(19) United States
(12) Patent Application Publication
(10) Pub. No.: US 2026/0222167 A1
(43) Pub. Date: Jul. 30, 2026

(54) UPLINK CONTROL CHANNEL REPETITION WITHOUT A DEDICATED RESOURCE CONFIGURATION IN SUB-BAND FULL DUPLEX

(71) Applicant: QUALCOMM Incorporated, San Diego, CA (US)

(72) Inventors: Hung Dinh LY, San Diego, CA (US); Muhammad Sayed Khairy ABDELGHAFFAR, San Jose, CA (US)

(21) Appl. No.: 19/039,592

(22) Filed: Jan. 28, 2025

(51) Int. Cl. H04L 5/14; H04W 72/0453; H04W 72/21

(52) U.S. Cl. CPC H04L 5/14; H04W 72/0453; H04W 72/21

(57) ABSTRACT

Methods, systems, and devices for wireless communications are described. A user equipment (UE) may receive control signaling indicating whether a network entity supports physical uplink control channel repetitions via a set of sub-band full duplex (SBFD) symbols or a set of non-SBFD symbols in accordance with a first configuration, or via both SBFD symbols and non-SBFD symbols in accordance with a second configuration. The UE may select, for a feedback message corresponding to a random access procedure, at least a subset of symbols in accordance with the first configuration or the second configuration and a set of frequency resources in accordance with one or more parameters, and the UE may transmit one or more repetitions of the feedback message via at least the subset symbols and the set of frequency resources.

### FIELD OF TECHNOLOGY

The following relates to wireless communications, including uplink control channel repetition without a dedicated resource configuration in sub-band full duplex.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicating whether a network entity supports physical uplink control channel (PUCCH) repetitions via a first set of symbols including a set of sub-band full duplex (SBFD) symbols or a set of non-SBFD symbols in accordance with a first configuration, or via a second set of symbols including both SBFD symbols and non-SBFD symbols in accordance with a second configuration, selecting, for a feedback message corresponding to a random access (RACH) procedure, at least a subset of the first set of symbols or the second set of symbols in accordance with the first control signaling, and a set of frequency resources in accordance with one or more parameters, and transmitting one or more repetitions of the feedback message via at least the subset of the first set of symbols or the second set of symbols and the set of frequency resources in accordance with the selecting.

A UE for wireless communications is described. The UE may include at least one processor, and at least one memory coupled with the at least one processor, with instructions stored in the at least one memory, the instructions being executable by the at least one processor, individually or in any combination, to cause the UE to receive first control signaling indicating whether a network entity supports PUCCH repetitions via a first set of symbols including a set of SBFD symbols or a set of non-SBFD symbols in accordance with a first configuration, or via a second set of symbols including both SBFD symbols and non-SBFD symbols in accordance with a second configuration, select, for a feedback message corresponding to a RACH procedure, at least a subset of the first set of symbols or the second set of symbols in accordance with the first control signaling, and a set of frequency resources in accordance with one or more parameters, and transmit one or more repetitions of the feedback message via at least the subset of the first set of symbols or the second set of symbols and the set of frequency resources in accordance with the selecting.

Another UE for wireless communications is described. The UE may include means for receiving first control signaling indicating whether a network entity supports PUCCH repetitions via a first set of symbols including a set of SBFD symbols or a set of non-SBFD symbols in accordance with a first configuration, or via a second set of symbols including both SBFD symbols and non-SBFD symbols in accordance with a second configuration, means for selecting, for a feedback message corresponding to a RACH procedure, at least a subset of the first set of symbols or the second set of symbols in accordance with the first control signaling, and a set of frequency resources in accordance with one or more parameters, and means for transmitting one or more repetitions of the feedback message via at least the subset of the first set of symbols or the second set of symbols and the set of frequency resources in accordance with the selecting.

A non-transitory computer-readable medium storing code for wireless communications is described. The code may include instructions executable by one or more processors to receive first control signaling indicating whether a network entity supports PUCCH repetitions via a first set of symbols including a set of SBFD symbols or a set of non-SBFD symbols in accordance with a first configuration, or via a second set of symbols including both SBFD symbols and non-SBFD symbols in accordance with a second configuration, select, for a feedback message corresponding to a RACH procedure, at least a subset of the first set of symbols or the second set of symbols in accordance with the first control signaling, and a set of frequency resources in accordance with one or more parameters, and transmit one or more repetitions of the feedback message via at least the subset of the first set of symbols or the second set of symbols and the set of frequency resources in accordance with the selecting.

Some examples of the method, UEs, and non-transitory computer-readable medium described herein may further include operations, features, means, or instructions for receiving second control signaling indicating a first parameter of the one or more parameters, the first parameter indicating a threshold time offset between receiving a downlink message corresponding to the RACH procedure and a first repetition of the one or more repetitions of the feedback message and transmitting the first repetition of the feedback message via a next available SBFD symbol of the set of SBFD symbols or a next available non-SBFD symbol of the set of non-SBFD symbols in accordance with the first parameter and the first configuration.

Some examples of the method, UEs, and non-transitory computer-readable medium described herein may further include operations, features, means, or instructions for determining, in accordance with the first configuration, whether the first repetition was transmitted via an SBFD symbol or a non-SBFD symbol, where selecting at least the subset of the first set of symbols includes selecting the set of SBFD symbols or the set of non-SBFD symbols may be based on the determining and transmitting one or more additional repetitions of the one or more repetitions of the feedback message via SBFD symbols or non-SBFD symbols in accordance with the selecting.

Some examples of the method, UEs, and non-transitory computer-readable medium described herein may further include operations, features, means, or instructions for receiving second control signaling indicating a frequency offset, where selecting the set of frequency resources for the feedback message may be in accordance with the frequency offset.

In some examples of the method, UEs, and non-transitory computer-readable medium described herein, selecting the set of frequency resources may include operations, features, means, or instructions for selecting, in accordance with the first configuration and the frequency offset, a first subset of frequency resources associated with SBFD symbols, where a second subset of frequency resources may be associated with non-SBFD symbols, and where the first subset of frequency resources may be offset from the second subset of frequency resources by the frequency offset.

In some examples of the method, UEs, and non-transitory computer-readable medium described herein, selecting the set of frequency resources may include operations, features, means, or instructions for selecting, in accordance with the second configuration and the frequency offset, the set of frequency resources associated with the second set of symbols including both SBFD symbols and non-SBFD symbols, where the set of frequency resources may be offset from an indicated frequency resource associated with the non-SBFD symbols by the frequency offset.

Some examples of the method, UEs, and non-transitory computer-readable medium described herein may further include operations, features, means, or instructions for transmitting an indication of whether the UE supports PUCCH repetitions via the first set of symbols in accordance with the first configuration or via the second set of symbols in accordance with the second configuration.

Some examples of the method, UEs, and non-transitory computer-readable medium described herein may further include operations, features, means, or instructions for transmitting the indication via a third message of the RACH procedure.

In some examples of the method, UEs, and non-transitory computer-readable medium described herein, the indication includes a logical channel identifier (LCID) message.

Some examples of the method, UEs, and non-transitory computer-readable medium described herein may further include operations, features, means, or instructions for receiving second control signaling indicating one or more reference signal received power (RSRP) thresholds and applying a reference signal received power threshold to one or more measurements, where transmitting the one or more repetitions of the feedback message may be based on the applying.

Some examples of the method, UEs, and non-transitory computer-readable medium described herein may further include operations, features, means, or instructions for receiving second control signaling indicating one or more repetition quantities, where transmitting the one or more repetitions of the feedback message may be based on the one or more repetition quantities.

In some examples of the method, UEs, and non-transitory computer-readable medium described herein, the first control signaling includes a system information block (SIB), a random access response (RAR) message, downlink control information (DCI), or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports uplink control channel repetition without a dedicated resource configuration in sub-band full duplex in accordance with one or more aspects of the present disclosure.

FIG. 2 shows an example of a wireless communications system that supports uplink control channel repetition without a dedicated resource configuration in sub-band full duplex in accordance with one or more aspects of the present disclosure.

FIG. 3 shows an example of a timing diagram that supports uplink control channel repetition without a dedicated resource configuration in sub-band full duplex in accordance with one or more aspects of the present disclosure.

FIG. 4 shows an example of a resource diagram that supports uplink control channel repetition without a dedicated resource configuration in sub-band full duplex in accordance with one or more aspects of the present disclosure.

FIG. 5 shows an example of a process flow that supports uplink control channel repetition without a dedicated resource configuration in sub-band full duplex in accordance with one or more aspects of the present disclosure.

FIGS. 6 and 7 show block diagrams of devices that support uplink control channel repetition without a dedicated resource configuration in sub-band full duplex in accordance with one or more aspects of the present disclosure.

FIG. 8 shows a block diagram of a communications manager that supports uplink control channel repetition without a dedicated resource configuration in sub-band full duplex in accordance with one or more aspects of the present disclosure.

FIG. 9 shows a diagram of a system including a device that supports uplink control channel repetition without a dedicated resource configuration in sub-band full duplex in accordance with one or more aspects of the present disclosure.

FIGS. 10 through 12 show flowcharts illustrating methods that support uplink control channel repetition without a dedicated resource configuration in sub-band full duplex in accordance with one or more aspects of the present disclosure.

### DETAILED DESCRIPTION

In some wireless communications systems, a user equipment (UE) and a network entity may perform a random access procedure such as a random access channel (RACH) procedure (e.g., to establish a connection, or initiate wireless communications, among other examples). In some examples, the UE may transmit feedback such as hybrid automated request (HARQ) acknowledgment (ACK) feedback (e.g., HARQ-ACK) in response to receiving one or more messages (e.g., random access message corresponding to the random access procedure). For example, the UE may transmit HARQ-ACK feedback in response to a last message of the random access procedure (e.g., a fourth message (Msg4) of a four-step random access procedure, among other examples). The UE may additionally support transmission of one or more repetitions of the HARQ-ACK feedback via one or more physical uplink control channel (PUCCH) repetitions. Such repetitions of the feedback may result in increased reliability for the feedback, and avoidance of unnecessarily repeated random access signaling.

However, in such examples, the network entity may not indicate a set of dedicated resources for such PUCCH repetitions to the UE (e.g., the UE may not be configured with a dedicated PUCCH resource configuration), and the UE may correspondingly utilize a PUCCH resource set indicated via system information in a system information block (SIB) (e.g., SIB1) for the PUCCH repetitions. Additionally, or alternatively, some wireless communications systems (e.g., UEs, network entities, or the like) may perform communications via sub-band full duplexing (SBFD), where a component carrier includes both non-overlapping uplink and downlink sub-bands (e.g., to enable simultaneous transmission and reception). However, in such cases, there may be ambiguity as to whether the network entity supports SBFD for the PUCCH repetitions, and whether the UE should transmit the PUCCH repetitions via SBFD slots, non-SBFD slots, or both. Additionally, the UE may not be able to utilize the PUCCH resource set indicated by system information to communicate the PUCCH repetitions via SBFD slots (e.g., if the indicated PUCCH resource set corresponds to a downlink sub-band in an SBFD slot, or if the PUCCH resource set corresponds to one type of resource, such as SBFD slots or non-SBFD slots, and the UE transmits the feedback repetition via the other type of resources). If the UE is not able to consistently or accurately select PUCCH resources for transmitting PUCCH repetitions (e.g., for a feedback message for a random access message), then the UE may not be able to transmit repetitions of the feedback message, or the network entity may not be able to monitor for and receive the repetitions of the feedback message, resulting in failed transmissions, failed random access procedures, and increased signaling overhead. Such inefficient use of system resources may result in increased system latency, decreased reliability of wireless signaling, and decreased throughput.

The techniques, methods, and devices described herein may enable uplink control channel repetition without a dedicated resource configuration (e.g., for devices that support wireless communications in SBFD mode). In some implementations, the network entity may indicate, via control signaling, whether the network entity supports a first mode (e.g., Configuration 1) for PUCCH repetitions via a set of SBFD symbols or via a set of non-SBFD symbols, or whether the network entity supports a second mode (e.g., Configuration 2) for PUCCH repetitions via both of a set of SBFD symbols and a set of non-SBFD symbols, or both (e.g., Configuration 1 and Configuration 2). In some examples, the network entity may additionally indicate a timing parameter associated with a first repetition of the PUCCH repetition, and the UE may determine a symbol type (e.g., SBFD or non-SBFD) for the PUCCH repetitions (e.g., when operating within Configuration 1) based on the timing parameter. Additionally, or alternatively, the network entity may indicate (e.g., via control signaling) one or more frequency offsets associated with the PUCCH repetitions (e.g., repetitions occupying SBFD slots, non-SBFD slots, or both), one or more reference signal received power (RSRP) thresholds associated with the PUCCH repetitions, one or more repetition quantities (e.g., repetition factors) for the PUCCH repetitions, or any combination thereof. The UE may transmit the PUCCH repetitions via SBFD slots or non-SBFD slots (e.g., according to Configuration 1), or both SBFD slots and non-SBFD slots (e.g., according to Configuration 2) based on the control signaling.

Aspects of the disclosure are initially described in the context of wireless communications systems. Aspects of the disclosure are further described in the context of wireless communication systems, timing diagrams, resource diagrams, and process flows. Aspects of the disclosure are further illustrated by and described with reference to apparatus diagrams, system diagrams, and flowcharts that relate to uplink control channel repetition without a dedicated resource configuration in sub-band full duplex.

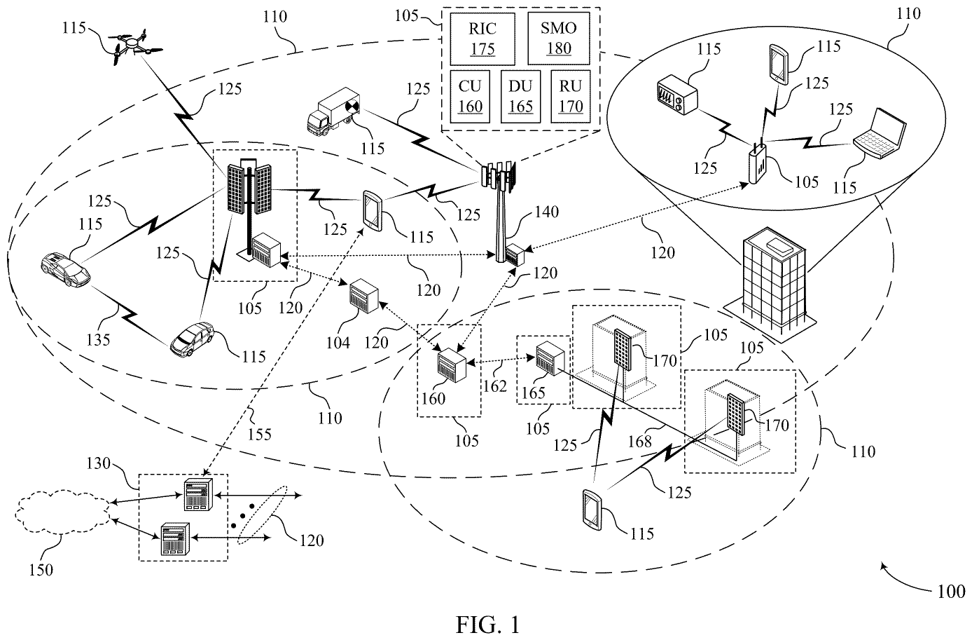

FIG. 1 shows an example of a wireless communications system 100 that supports uplink control channel repetition without a dedicated resource configuration in sub-band full duplex in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support uplink control channel repetition without a dedicated resource configuration in SBFD as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The techniques, methods, and devices described herein may enable uplink control channel repetition without a dedicated resource configuration (e.g., for devices that support wireless communications in SBFD mode). In some implementations, the network entity may indicate, via control signaling, whether the network entity supports a first mode (e.g., Configuration 1) for PUCCH repetitions via a set of SBFD symbols or via a set of non-SBFD symbols, or whether the network entity supports a second mode (e.g., Configuration 2) for PUCCH repetitions via both of a set of SBFD symbols and a set of non-SBFD symbols, or both (e.g., Configuration 1 and Configuration 2). In some examples, the network entity may additionally indicate a timing parameter associated with a first repetition of the PUCCH repetition, and the UE may determine a symbol type (e.g., SBFD or non-SBFD) for the PUCCH repetitions (e.g., when operating within Configuration 1) based on the timing parameter. Additionally, or alternatively, the network entity may indicate (e.g., via control signaling) one or more frequency offsets associated with the PUCCH repetitions (e.g., repetitions occupying SBFD slots, non-SBFD slots, or both), one or more reference signal received power (RSRP) thresholds associated with the PUCCH repetitions, one or more repetition quantities (e.g., repetition factors) for the PUCCH repetitions, or any combination thereof. The UE may transmit the PUCCH repetitions via SBFD slots or non-SBFD slots (e.g., according to Configuration 1), or both SBFD slots and non-SBFD slots (e.g., according to Configuration 2) based on the control signaling.

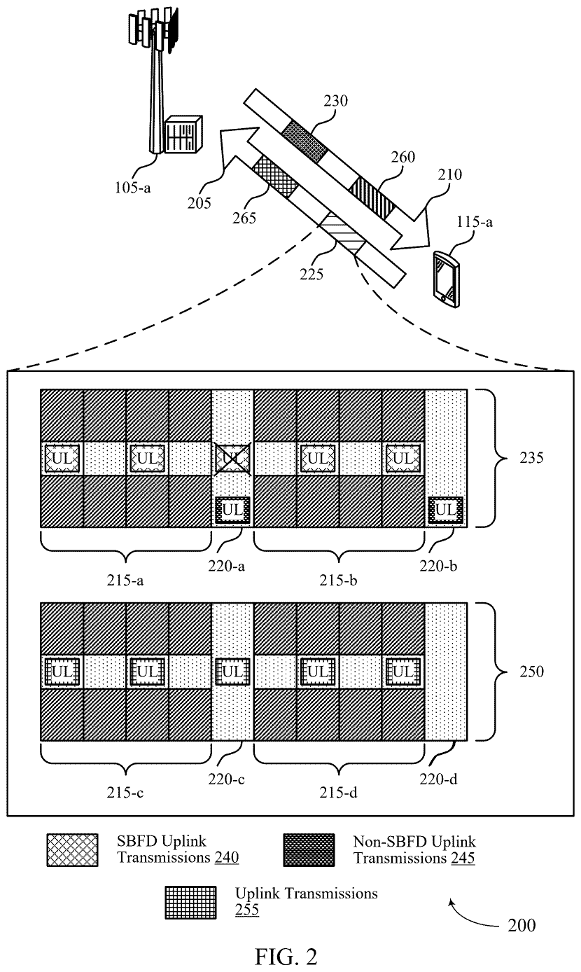

FIG. 2 shows an example of a wireless communications system 200 that supports uplink control channel repetition without a dedicated resource configuration in SBFD in accordance with one or more aspects of the present disclosure. Aspects of the wireless communications system 200 may implement or be implemented by aspects of wireless communications system 100. For example, the wireless communications system 200 may include a network entity 105-a and a UE 115-a, which may be examples of the network entity 105 and the UE 115 respectively.

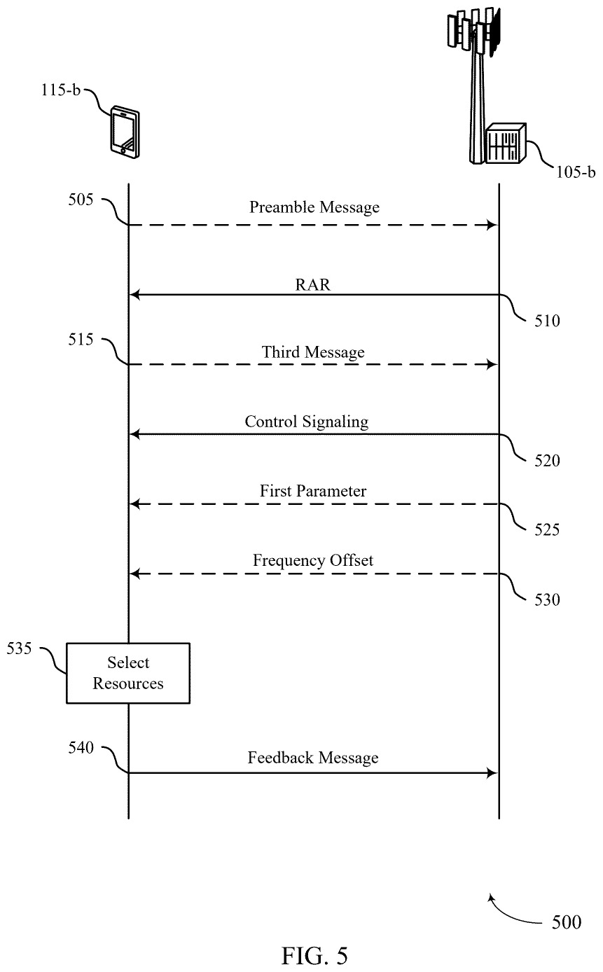

In some cases, the UE 115-a and the network entity 105-a may perform a random access procedure such as a RACH procedure, as further described herein with reference to FIG. 5. In some examples, the RACH procedure may be a two-step RACH procedure or a four-step RACH procedure, and the UE 115-a may report HARQ-ACK feedback for a last message (e.g., a last received message, such as a MsgB or a Msg4) of the RACH procedure. For example, in a four-step RACH procedure, the UE 115-a may send HARQ-ACK feedback in response to the Msg4 (e.g., physical downlink shared channel (PDSCH)) reception, and in a two-step RACH procedure, the UE 115-a may send HARQ-ACK feedback in response to a last message of the two-step RACH (e.g., MsgB) PDSCH reception. In some cases, the UE 115-a may output one or more repetitions of a feedback message, such as the HARQ-ACK feedback, via one or more PUCCH repetitions 225.

In some cases, the UE 115-a may output the HARQ-ACK feedback via a PUCCH without a dedicated PUCCH resource configuration. That is, the network entity 105-a may not indicate a PUCCH resource configuration to the UE 115-a (e.g., an explicit configuration via RRC signaling, or the like). In some examples, (e.g., when UE is not configured with dedicated PUCCH resources), the network entity 105-a may indicate, via a SIB (e.g., SIB1, or remaining minimum system information (RMSI)) a PUCCH resource set to the UE 115-a. In such cases, the network entity 105-a may indicate, via the SIB, an index (e.g., row) of a PUCCH resource set table, which is shown in Table 1 below. In such cases, the UE 115-a may perform PUCCH repetition after the UE 115-a receives a dedicated PUCCH resource set (e.g., after RRC connection) and receives a repetition factor for PUCCH repetition (e.g., through RRC configuration). Accordingly, in such cases (e.g., before RRC connection, where the UE 115-a has not received a dedicated PUCCH resource), the UE 115-a, the network entity 105-a, or both may not support PUSCH repetition.

TABLE 1
PUCCH Resource Sets Before Dedicated PUCCH
Resource Configuration

| | | | | | Set of |
|---|---|---|---|---|---|
| | PUCCH | First | Number of | | Initial CS |
| Index | Format | Symbol | Symbols | PRB Offset | Indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $[ \frac{{N}_{BWP}^{s i z e}}{4} ]$ | {0, 3, 6, 9} |

In some other cases, the UE 115-a may support PUCCH repetition (e.g., Msg4 HARQ-ACK repetition) without a dedicated PUCCH resource. The UE 115-a may send, via a third message of the random access procedure (e.g., Msg3), a request for Msg4 HARQ-ACK repetition, an indication of a capability to perform Msg4 HARQ-ACK repetition, or both. Accordingly, the network entity 105-a may indicate, via a PDCCH message of Msg4, a quantity of repetitions (e.g., a repetition factor) for a Msg4 HARQ-ACK feedback message.

In some cases, the network entity 105-a may transmit an indication of an RSRP threshold (e.g., a signal quality threshold) for the PUCCH repetition (e.g., Msg4 HARQ-ACK repetition). The PUCCH repetition RSRP threshold may be different (e.g., independent) from a RSRP threshold associated with Msg3 repetition. If the PUCCH repetition RSRP threshold is configured and if the UE 115-a supports PUCCH repetitions (e.g., the one or more PUCCH repetitions 225) for Msg 4 HARQ-ACK, the UE 115-a may output a report (e.g., via Msg3) indicating the capability of PUCCH repetition for Msg4 HARQ-ACK based on a measured RSRP being lower than the RSRP threshold. Additionally, or alternatively, if the PUCCH repetition RSRSP threshold is not configured, the UE 115-a may output a report indicating the capability of PUCCH repetition for Msg4 HARQ-ACK independent of a measured RSRP value.

In some cases, the network entity 105-a may transmit an indication of one or more repetition quantities (e.g., repetition factors) for the PUCCH repetition. The network entity 105-a may transmit the indication via a SIB (e.g., SIB1, or the like). For example, the network entity 105-a may indicate a single repetition factor of a set of candidate repetition factors (e.g., a set of {2, 4, 8}). As such, the UE 115-a may perform PUCCH repetition for Msg4 HARQ-ACK according to the repetition factor (e.g., the UE 115-a may repeat a Msg4 HARQ-ACK transmission a quantity of times indicated by the repetition factor). Additionally, or alternatively, the network entity 105-a may transmit an indication of multiple repetition factors (e.g., a set of {1, 2, 4, 8}, or the like). Accordingly, the network entity 105-a may dynamically determine and indicate a repetition factor of the set of repetition factors for the UE 115-a to apply to PUCCH repetition.

In some cases, the UE 115-a may output the request for Msg4 HARQ-ACK repetition, an indication of the capability to perform Msg4 HARQ-ACK repetition, or both via a logical channel identifier (LCID) codepoint included within Msg3. In some cases (e.g., in response to the indication or the request of Msg3), the network entity 105-a may output a downlink control information (DCI) message (e.g., DCI format 1_0 with a cyclic redundancy check (CRC) scrambled by a temporary cell radio network temporary identifier (TC-RNTI)) to dynamically indicate the repetition factor of the set of repetition factors (e.g., set of configured repetition factors). The DCI may include a downlink assignment indicator (DAI) field, and a set of bits of the DAI may indicate the repetition factor. For an illustrative example, a 1st, 2nd, 3rd, and 4th repetition factor (e.g., configured repetition factors) may be mapped to bit patterns ‘00’, ‘01’, ‘10’, ‘11’ of the DAI field, respectively. In such examples, if the network entity 105-a does not configure and indicate the 3rd and 4th repetition factors, the corresponding codepoints (e.g., ‘10’, ‘11’, or both) are not used.

In some cases, the network entity 105-a and the UE 115-a may communicate via a SBFD scheme (e.g., a duplexing scheme for TDD bands). In such cases, the network entity 105-a and the UE 115-a may communicate via non-overlapping (e.g., non-overlapping in frequency) uplink and downlink sub-bands, which may enable the network entity 105-a, the UE 115-a, or both to perform simultaneous transmission and reception (e.g., with relatively fewer interference mitigation techniques compared to other full-duplex schemes). The non-overlapping uplink and downlink sub-bands may be examples of the uplink sub-band 205 and the downlink sub-band 210, respectively. The uplink sub-band 205 and the downlink sub-band 210 may each include a portion of bandwidth (BW) of a component carrier (not shown) associated with communications between the network entity 105-a and the UE 115-a. Performing communications via the SBFD scheme may enable contiguous uplink transmissions in the uplink sub-band across multiple consecutive SBFD slots, which may relatively improve an uplink signal to noise ratio (SINR) (e.g., compared to non-SBFD schemes). Performing communications via the SBFD scheme may additionally relatively decrease uplink and downlink queuing (e.g., scheduling, or the like) and latency (e.g., compared to non-SBFD schemes).

In some cases, for uplink transmissions and downlink receptions across SBFD symbols 215 and non-SBFD symbols 220 in different slots (e.g., where each transmission or reception within a slot has either all SBFD symbols 215 or all non-SBFD symbols 220) for an SBFD aware UE (e.g., a UE supporting SBFD operations such as the UE 115-a), the network entity 105-a may provide the SBFD-aware UE 115-a with one or more configurations. For a first configuration (e.g., Configuration 1) transmissions, receptions, or both are restricted to the SBFD symbols 215 only or the non-SBFD symbols 220 only. For a second configuration (e.g., Configuration 2), the transmissions, receptions, or both may be supported in the SBFD symbols 215 and the non-SBFD symbols 220. In some cases, a granularity of the configuration (e.g., per UE, per channel, per signal, or the like) may vary. Additionally, or alternatively, the network entity 105-a and the UE 115-a may perform communications according to Configuration 2 based on a capability of the UE 115-a to support Configuration 2 (e.g., subject to UE capability).

In some cases, there may be ambiguity as to whether the network entity 105-a supports communications via SBFD symbols, non-SBFD symbols, or both SBFD symbols and non-SBFD symbols. Accordingly, the UE 115-a may be unable to select resources corresponding to a supported configuration of the network entity 105-a (e.g., Configuration 1 or Configuration 2) and may be unable to transmit the one or more PUCCH repetitions 225. Additionally, or alternatively, the UE 115-a may transmit the one or more PUCCH repetitions 225 via one or more symbols having a symbol type unsupported by the network entity 105-a. For example, the UE 115-a may transmit the one or more PUCCH repetitions 225 via SBFD symbols, which may be unsupported by the network entity 105-a. In such examples, the network entity 105-a may be unable to receive the one or more PUCCH repetitions 225 (e.g., or the UE 115-a may refrain from communicating the one or more PUCCH repetitions 225) and an associated RACH procedure may correspondingly fail. In some examples, the UE 115-a may select resources autonomously for the one or more PUCCH repetitions 225, but without techniques to consistently select such resources, the network entity 105-b may fail to receive the one or more PUCCH repetitions 225. Such inconsistencies, failures, or delays in communicating the one or more PUCCH repetitions 225 (e.g., for random access feedback messages) may increase result in increased system latency, increased latency of establishing a connection between the network entity 105-a and the UE 115-a, inefficient use of available system resources, and decreased user experience, among other examples.

The techniques, methods, and devices described herein may support PUCCH repetition carrying Msg4 HARQ-ACK (e.g., HARQ-ACK in response to Msg4 PDSCH reception) in SBFD deployments. For example, the network entity 105-a and the UE 115-a may communicate one or more PUCCH repetitions 225 of the Msg4 HARQ-ACK according to Configuration 1 or Configuration 2.

In some implementations, the network entity 105-a may output control signaling 230 indicating whether the network entity 105-a supports Configuration 1, Configuration 2, or both. The network entity 105-a may provide the indication via a SIB (e.g., SIB1, or the like), a DCI such as a DCI format 0_0 with CRC scrambled with random access RNTI (RA-RNTI) or with TC-RNTI, a DCI format 1_0 with CRC scrambled with RA-RTNI or with TC-RNTI, or any combination thereof. In some examples, the network entity 105-a may provide the indication via a random access response (RAR) message, such as second message of the RACH procedure (e.g., Msg2). Additionally, or alternatively, the network entity 105-a and the UE 115-a may support Msg3 PUSCH repetitions as part of the RACH procedure, and, in such examples, the network entity 105-a may output an indication of a Msg3 PUSCH repetition configuration. Accordingly, the network entity 105-a and the UE 115-a may communicate one or more PUCCH repetitions 225 according to the Msg3 PUSCH repetition configuration (e.g., the use the configuration of PUCCH repetitions for Msg3 for repetition of the HARQ-ACK feedback for Msg4). That is, the control signaling 230 may be the SIB, the RAR, the DCI (e.g., DCI format 0_0 or DCI format 1_0), the Msg3 PUSCH configuration indication, or any combination thereof. In some examples, the network entity 105-a may refrain from outputting the control signaling 230 (e.g., the configuration of support of the first configuration or the second configuration is absent). Accordingly, the network entity 105-a and the UE 115-a may communicate the one or more PUCCH repetitions 225 according to a default configuration, such as Configuration 1 (e.g., configuration 1 is assumed by default or according to one or more rules).

For example, the network entity 105-a may output the control signaling 230 indicating the network entity 105-a supports Configuration 1. In such examples, the UE 115-a may transmit the one or more PUCCH repetitions 225 according to a transmission scheme 235 corresponding to Configuration 1. Accordingly, the UE 115-a may select the SBFD symbols 215 or the non-SBFD symbols 220 for transmission of the one or more PUCCH repetitions 225 (e.g., based on a capability of the UE 115-a, among other examples). For example, the UE 115-a may select a set of uplink slots including the SBFD symbols 215. Accordingly, the UE 115-a may output the one or more PUCCH repetitions 225 via one or more SBFD uplink transmissions 240 (e.g., according to a two-slot periodicity). For example, the UE 115-a may transmit a first repetition and a second repetition of the one or more PUCCH repetitions 225 via a first transmission of the one or more SBFD uplink transmissions 240 and a second transmission of the one or more SBFD uplink transmissions 240 respectively in one or more SBFD symbols 215-a, and the UE 115-a may transmit a third repetition and a fourth repetition of the one or more PUCCH repetitions 225 via a third transmission of the one or more SBFD uplink transmissions 240 and a fourth transmission of the one or more SBFD uplink transmissions 240 respectively in one or more SBFD symbols 215-b. In such examples, the UE 115-a may refrain from transmitting the one or more PUCCH repetitions 225 via the non-SBFD symbols 220.

In some examples, the network entity 105-a may output the control signaling 230 indicating the network entity 105-a supports Configuration 1, and the UE 115-a may select a set of uplink symbols including the non-SBFD symbols 220 in accordance with the transmission scheme 235. Accordingly, the UE 115-a may transmit the one or more PUCCH repetitions 225 via one or more non-SBFD uplink transmissions 245. For example, the UE 115-a may transmit a first repetition of the one or more PUCCH repetitions 225 via a first transmission of the non-SBFD uplink transmissions 245 in a non-SBFD symbol 220-a and a second repetition of the one or more PUCCH repetitions 225 via a second transmission of the non-SBFD uplink transmissions 245 in a non-SBFD symbol 220-b. In such examples, the UE 115-a may refrain from transmitting the one or more PUCCH repetitions 225 via the SBFD symbols 215.

In some examples, the network entity 105-a may output the control signaling 230 indicating the network entity 105-a supports Configuration 2. In such examples, the UE 115-a may transmit the one or more PUCCH repetitions 225 according to a transmission scheme 250 corresponding to Configuration 2. Accordingly, the UE 115-a may select the SBFD symbols 215, the non-SBFD symbols 220, or both for transmission of the one or more PUCCH repetitions 225. For example, the UE 115-a may select a set of symbols including both the SBFD symbols 215 and the non-SBFD symbols 220. In such examples, the UE 115-a may transmit the one or more PUCCH repetitions 225 according to a two-slot periodicity via one or more uplink transmissions 255 (e.g., periodic uplink transmissions) in one or more SBFD symbols 215-c, one or more SBFD symbols 215-d, a non-SBFD symbol 220-c, a non-SBFD symbol 220-d, or any combination thereof.

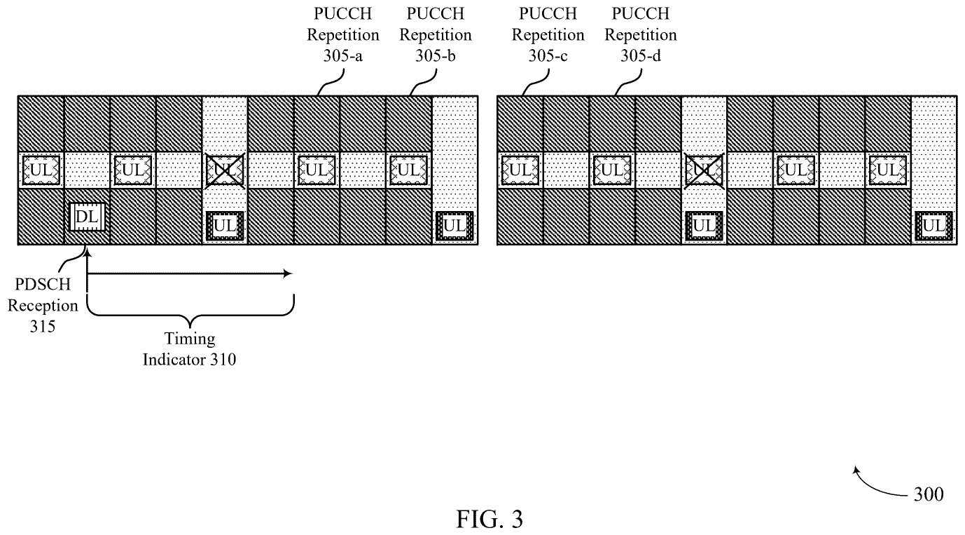

In some implementations, the network entity 105-a may output additional control signaling 260 (e.g., in a same message or a different message from the control signaling 230). In some examples, the UE 115-a may determine a symbol type (e.g., of the SBFD symbols 215 or the non-SBFD symbols 220) to be utilized for transmission of the one or more PUCCH repetitions 225 based on obtaining one or more timing parameters via the additional control signaling 260, which is further described herein with reference to FIG. 3. Additionally, or alternatively, the UE 115-a may determine one or more sets of frequency resources associated with the SBFD symbols 215, the non-SBFD symbols 220, or both based on one or more frequency offsets indicated via the additional control signaling 260. In such examples, the UE 115-a may transmit the one or more PUCCH repetitions 225 according to the one or more sets of frequency resources.

In some implementations, the UE 115-a may support PUCCH repetition via uplink slots such as the non-SBFD symbols 220 (e.g., similar to Configuration 1). Additionally, or alternatively, the UE 115-a may support PUCCH repetition via the SBFD symbols 215 (e.g., similar to the Configuration 1, the Configuration 2, or both). In some examples, the UE 115-a may transmit capability information 265 indicating whether the UE 115-a supports PUCCH repetition via the SBFD symbols 215, the non-SBFD symbols 220, or both.

FIG. 3 shows an example of a timing diagram 300 that supports uplink control channel repetition without a dedicated resource configuration in SBFD in accordance with one or more aspects of the present disclosure. Aspects of the timing diagram 300 may implement or be implemented by aspects of the wireless communications system 100, the wireless communications system 200, or both. For example, the timing diagram 300 may be an example of communications performed by a network entity and a UE, which may be examples of the network entity 105 and the UE 115 respectively.

In some implementations, the network entity may output control signaling indicating whether the network entity supports a first configuration (e.g., Configuration 1), a second configuration (e.g., Configuration 2), or both for one or more PUCCH repetitions 305, which is further described herein with reference to FIG. 2. That is, the network entity may indicate a configuration, based on which the UE may determine or select resources for one or more PUCCH repetitions 305 carrying HARQ-ACK feedback for a Msg4 of a RACH procedure via SBFD symbols, non-SBFD symbols, or both SBFD and non-SBFD symbols.

In some implementations, the network entity may support PUCCH repetitions (e.g., the one or more PUCCH repetitions 305) via SBFD symbols or non-SBFD symbols (e.g., Configuration 1) and may accordingly output control signaling indicating support for Configuration 1 (e.g., to the UE). In some examples, the network entity may output an indication (e.g., via control signaling, among other examples) of a symbol type to use for the one or more PUCCH repetitions 305. That is, the network entity may explicitly indicate to the UE to transmit the one or more PUCCH repetitions 305 via SBFD symbols or non-SBFD symbols (e.g., in accordance with Configuration 1). For example, the network entity may output control signaling indicating support for Configuration 1, and may additionally output an indication to the UE to transmit the one or more PUCCH repetitions 305 via non-SBFD symbols. Accordingly, the UE may transmit the one or more PUCCH repetitions 305 via non-SBFD symbols, and may refrain from transmitting the one or more PUCCH repetitions 305 via SBFD symbols. Or, the network entity may output control signaling indicating support for Configuration 1, and may additionally output an indication to the UE to transmit the one or more PUCCH repetitions 305 via SBFD symbols. Accordingly, the UE may transmit the one or more PUCCH repetitions 305 via SBFD symbols, and may refrain from transmitting the one or more PUCCH repetitions 305 via non-SBFD symbols

In some implementations, the UE may determine a symbol type for one or more PUCCH repetitions (e.g., SBFD symbols or non-SBFD symbols) via PUCCH transmission timing. For example, the network entity may schedule a PDSCH communication (e.g., such as a PDSCH reception 315) via a DCI message (e.g., DCI format 1_0 with CRC scrambled by TC-RNTI, among other examples), which may be associated with a feedback transmission (e.g., a PUCCH transmission for Msg4 HARQ-ACK). The network entity may additionally output, via the control signaling, one or more timing parameters associated with a timing of the PUCCH transmission such as a timing indicator 310. For example, the DCI may schedule the PDSCH reception 315 and may further include a PDSCH-to-HARQ_feedback timing indicator, which may indicate a timing of the PUCCH transmission relative to the PDSCH reception 315 (e.g., an offset time between a slot where the PDSCH reception 315 is received and the corresponding PUCCH transmission). In some cases, the UE may select the type of resources (e.g., SBFD symbols or non-SBFD symbols) based on the timing indicator.

For example, the network entity may output, and the UE may receive, the DCI scheduling a PDSCH message in a downlink slot n (e.g., the PDSCH reception 315). In such examples, the DCI may include the PDSCH-to-HARQ_feedback timing indicator, which may indicate a value of k, where k is an offset duration of time, an offset quantity of slots, an offset quantity of symbols, or the like from the PDSCH reception 315 (e.g., from a last slot n of the PDSCH scheduled by the DCI). As such, the UE may transmit, the first repetition of the PUCCH transmission in a next available occasion after slot n+k (e.g., k slots after the downlink slot n, among other examples).

In some implementations, the UE may determine a slot type for the one or more PUCCH repetitions 305 based on the timing indicator 310 (e.g., the PDSCH-to-HARQ_feedback timing indicator) and on operating according to Configuration 1. For example, the UE may receive control signaling scheduling the PDSCH reception 315 and including the timing indicator 310. Accordingly, the UE may determine a slot associated with the scheduled PDSCH reception 315 and a first (e.g., first available, or next) uplink slot for transmitting a PUCCH repetition of the feedback message based on the timing indicator 310 (e.g., the first slot may be an offset quantity of slots or symbols from the PDSCH reception 315 slot or symbol, among other examples). Accordingly, the UE may transmit a first PUCCH repetition 305-a of the one or more PUCCH repetitions 305 via the first uplink slot. In some examples, the UE may transmit the first PUCCH repetition 305-a in the first uplink slot via a SBFD symbol (e.g., if the next available uplink occasion for transmitting the PUCCH repetition occurs in an SBFD symbol), and the UE may accordingly transmit one or more second repetitions of the one or more PUCCH repetitions 305 according to a repetition factor (e.g., a repetition factor indicated by the network entity via control signaling, among other examples) via SBFD symbols (e.g., based on the first PUCCH repetition 305-a occupying a SBFD symbol). For example, the UE may output, after the first PUCCH repetition 305-a, a PUCCH repetition 305-b, a PUCCH repetition 305-c, and a PUCCH repetition 305-d via one or more SBFD symbols after the first uplink slot (e.g., corresponding to a repetition factor of four).

Additionally, or alternatively, the UE may transmit the first PUCCH repetition 305-a via a non-SBFD symbol when the next available occasion for transmitting the PUCCH feedback message occurs in a non-SBFD symbol. In such examples, the UE may accordingly transmit one or more remaining PUCCH repetitions of the one or more PUCCH repetitions 305(e.g., the PUCCH repetition 305-b, the PUCCH repetition 305-c, the PUCCH repetition 305-d, or the like) via non-SBFD symbols. For example, if the timing indicator 310 had a duration of 7 slots (e.g., not shown), then the next available opportunity to transmit the PUCCH feedback may occur in a non-SBFD symbol, in which case the UE may transmit all repetitions of the PUCCH feedback message via non-SBFD symbols.

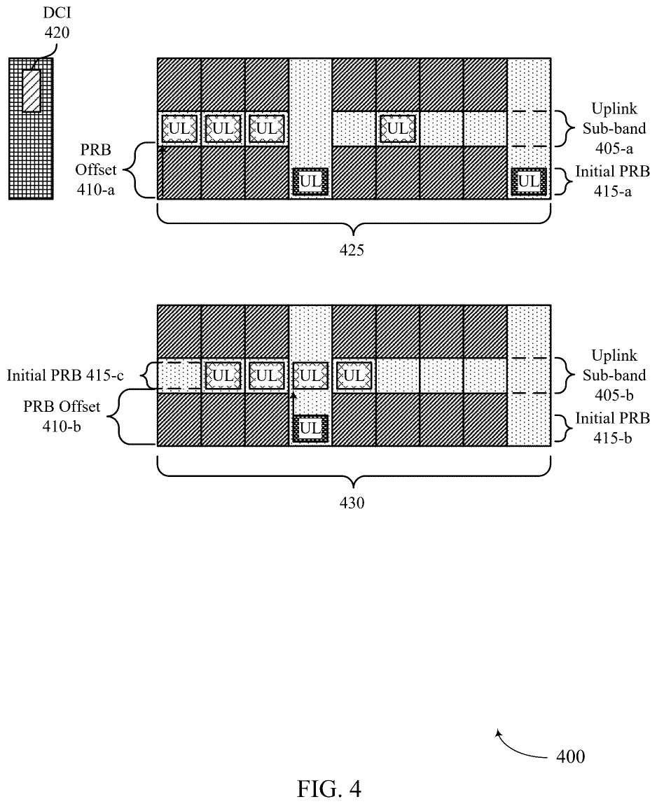

FIG. 4 shows an example of a resource diagram 400 that supports uplink control channel repetition without a dedicated resource configuration in SBFD in accordance with one or more aspects of the present disclosure. Aspects of the resource diagram 400 may implement or be implemented by aspects of the wireless communications system 100, the wireless communications system 200, or both. For example, the resource diagram 400 may be an example of communications performed by a network entity and a UE, which may be examples of the network entity 105 and the UE 115 respectively.

In some cases, the network entity may communicate according to a first configuration (e.g., Configuration 1), a second configuration (e.g., Configuration 2), or both, as further described herein with reference to FIG. 2. That is, the network entity and the UE may communicate via SBFD symbols or non-SBFD symbols (e.g., Configuration 1), or both SBFD and non-SBFD symbols (e.g., Configuration 2).

In some cases, the network entity may refrain from providing an indication of a dedicated resource allocation for one or more PUCCH repetitions (e.g., PUCCH repetitions carrying Msg4 HARQ-ACK feedback information). Accordingly, the UE may perform the PUCCH repetitions via a PUCCH resource set of a PUCCH resource set table (e.g., shown in Table 1), as further described herein with reference to FIG. 2. In some examples, a frequency resource such as a physical resource block (PRB) indicated by the PUCCH resource set table may not be aligned with a frequency resource associated with the SBFD symbols (e.g., the PUCCH resource allocation may not fall within an uplink sub-band 405 of an SBFD channel). Additionally, or alternatively, the UE may align each PUCCH repetition of the PUCCH repetitions in frequency such that each PUCCH repetition corresponds to a same frequency resource (e.g., a same PRB). For example, the UE may align each PUCCH repetition in frequency across SBFD symbols and non-SBFD symbols based on operating according to Configuration 2.

The techniques, methods, and devices described herein may enable the network entity and the UE to communicate the PUCCH repetitions utilizing the PUCCH resource set of a PUCCH resource set table (e.g., without a dedicated PUCCCH resource) via one or more frequency offsets (e.g., PRB offsets).

In some implementations, the network entity may output control signaling indicating a PRB offset 410. The network entity may output the control signaling via a SIB (e.g., SIB1), or via RRC signaling, among other examples (e.g., based on whether the network entity is associated with a primary cell (PCell) or a secondary cell (SCell) of the UE). In some examples, the PRB offset 410 may indicate a frequency offset value from a reference frequency resource (e.g., a reference resource allocation, or an initial resource allocation). For example, the UE may select (e.g., based on an indication of an index value from the network entity, among other examples) a PUCCH resource set from the PUCCH resource set table, which may include an initial PRB 415.

Additionally, or alternatively, the network entity may output a DCI 420 (e.g., DCI 1_0 with CRC scrambled by TC-RNTI) indicating a resource allocation including a frequency resource (e.g., a PRB) for the PUCCH repetitions including the initial PRB 415. The selected PUCCH resource may include a frequency resource associated with a non-SBFD uplink transmission (e.g., the initial PRB 415), and the UE may be unable to transmit the PUCCH repetitions via SBFD symbols in accordance with the selected PUCCH resource set (e.g., because the frequency resources for the PUCCH resource set are located in the downlink sub-band). In such examples, the PRB offset 410 may indicate a frequency offset value from the initial PRB 415, and the UE may utilize the initial PRB 415 with the PRB offset 410 to identify the frequency resources via which to transmit the PUCCH repetitions in SBFD symbols (e.g., via the uplink sub-band 405 of the SBFD channel). That is, the PRB offset 410 may indicate a PRB (not shown) associated with the uplink sub-band 405 based on the initial PRB 415.

For example, the UE may transmit one or more PUCCH repetitions according to a transmission scheme 425 (e.g., corresponding to Configuration 1). The UE may select a PUCCH resource set from the PUCCH resource set table including an initial PRB 415-a, which may be associated with a non-SBFD symbol (e.g., an uplink slot). In some examples, the network entity may output an indication of a PRB offset 410-a, which may be an offset frequency value from the initial PRB 415-a. In some examples, the UE may transmit the one or more PUCCH repetitions via non-SBFD symbols (e.g., according to Configuration 1 and one or more conditions, such as a UE capability, among other examples). Accordingly, the UE may transmit the PUCCH repetitions via the non-SBFD symbols using the initial PRB 415-a. Additionally, or alternatively, the UE may transmit the PUCCH repetitions via SBFD symbols within an uplink sub-band 405-a (e.g., but not via non-SBFD symbols in accordance with Configuration 1). In such examples, the initial PRB 415-a may be unaligned with the uplink sub-band 405-a (e.g., the initial PRB 415-a may correspond to frequency resources not included within the uplink sub-band 405-a, such as a downlink sub-band, among other examples). In such examples, the UE may output the PUCCH repetitions via the SBFD symbols in the uplink sub-band 405-a. The UE may select the appropriate frequency resources for transmitting the PUCCH repetitions of a feedback message using the initial PRB 415-a and the PRB offset 410-a. That is, the PRB offset may indicate, based on the initial PRB 415-a (e.g., a reference PRB), one or more frequency resources (e.g., one or more PRBs or an offset starting PRB) included within the uplink sub-band 405-a, and the UE may transmit the PUCCH reptations via the PRB of the uplink sub-band 405-a (not shown).

In some examples, the UE may transmit the PUCCH repetitions according to a transmission scheme 430 (e.g., corresponding to Configuration 2). In some examples, the UE may select a PUCCH resource set from the PUCCH resource set table including an initial PRB 415-b, which may be associated with a non-SBFD symbol (e.g., an uplink slot). In such examples, the network entity may output an indication of a PRB offset 410-b, which may be indicate a frequency offset value from the initial PRB 415-b. Accordingly, the UE may apply the PRB offset 410-b and may transmit the PUCCH repetitions within an uplink sub-band 405-b. For example, the UE may transmit one or more PUCCH repetitions via SBFD symbols within the uplink sub-band 405-b, one or more PUCCH repetitions via non-SBFD symbols within the uplink sub-band 405-b, or both based on the initial PRB 415-b and the PRB offset 410-b. For instance, the initial PRB 415-b and the PRB offset 410-b may be applied such that the UE is able to transmit the repetitions (e.g., four repetitions) via the same set of frequency resources across SBFD symbols and non-SBFD symbols).

Additionally, or alternatively, network entity may indicate, or the UE may select, among other examples, an initial PRB 415-c corresponding to the uplink sub-band 405-b. That is, the initial PRB 415-c may be a PRB associated with an initial SBFD symbol (e.g., a first usable PRB of the uplink sub-band 405-b. Accordingly, the PRB offset 410-b may be based on the initial PRB 415-c. In such examples, the UE may transmit one or more PUCCH repetitions via SBFD symbols within the uplink sub-band 405-b, one or more PUCCH repetitions via non-SBFD symbols within the uplink sub-band 405-b, or both based on the initial PRB 415-c and the PRB offset 410-b.

FIG. 5 shows an example of a process flow 500 that supports uplink control channel repetition without a dedicated resource configuration in SBFD in accordance with one or more aspects of the present disclosure. Aspects of the process flow 500 may implement or be implemented by aspects of the wireless communications system 100, the wireless communications system 200, or both. For example, the process flow 500 may include a network entity 105-b and a UE 115-b, which may be examples of the network entity 105 and the UE 115 respectively. The process flow 500 may be an example of a RACH procedure performed between the network entity 105-b and the UE 115-b, among other examples.

In the following description of the process flow 500, the operations between the network entity 105-b, and the UE 115-b may be performed in different orders or at different times. Some operations may also be left out of the process flow 500, or other operations may be added. Although the network entity 105-b, and the UE 115-b are shown performing the operations of the process flow 500, some aspects of some operations may also be performed by one or more other wireless devices.

At 505, the UE 115-b may transmit a preamble message (e.g., a Msg1, or a PRACH) as part of the RACH procedure. At 510, the network entity 105-b may, in response to the preamble message, output a RAR message (e.g., a Msg2) as part of the random access procedure.

At 515, the UE 115-b may, in response to the RAR message, or the like, transmit a third message (e.g., a Msg3) as part of the RACH procedure. The UE 115-b may send, via the third message of the random access procedure, a request for Msg4 HARQ-ACK repetition (e.g., PUCCH repetition), an indication of a capability to perform Msg4 HARQ-ACK repetition, or both. That is, the UE 115-b (e.g., a UE capable of PUCCH repetition for Msg4 HARQ-ACK) may transmit an indication reporting the capability of PUCCH repetition to the network entity 105-b. For example, the UE 115-b may transmit the request, the capability indication, or both via an LCID of the third message (e.g., a LCID of Msg3).

In some implementations, the UE 115-b may support PUCCH repetitions via one or more (e.g., two) implementations based on the UE 115-b supporting PUCCH repetitions for HARQ-ACK feedback. For example, the UE 115-b may support a first implementation (e.g., Implementation 1) for PUCCH repetition in uplink slots (e.g., non-SBFD symbols), a second implementation (e.g., Implementation 2) for PUCCH repetition in SBFD slots, or both. Accordingly, the UE 115-b may transmit an indication of whether the UE 115-b supports the first implementation, the second implementation, or both. For example, the UE 115-b may transmit the indication via one or more LCIDs (e.g., reserved LCIDs) of the third message (e.g., LCIDs of Msg3).

At 520, the network entity 105-b may output control signaling (e.g., as part of the RACH procedure such as a Msg4 of the RACH procedure, system information, RRC signaling, a DCI message, among other examples). The control signaling may include an indication of whether the network entity 105-b supports PUCCH repetitions via SBFD symbols or non-SBFD symbols (e.g., Configuration 1), or via both SBFD symbols and non-SBFD symbols. In some examples, the network entity 105-a may output the control signaling based on obtaining the indication of 515 from the UE 115-b indicating whether the UE 115-b supports PUCCH repetitions via SBFD symbols, non-SBFD symbols, or both (e.g., Implementation 1 or Implementation 2). The control signaling may include a SIB, a DCI (e.g., DCI format 0_0 or DCI format 1_0 with CRC scrambled by RA-RNTI or CRC scrambled by TC-RNTI), or any combination thereof. In some examples, the network entity 105-b may output the indication via the RAR of 510. Additionally, or alternatively, the network entity 105-b may output an indication of one or more parameters associated with Msg3 PUSCH repetition via the RAR of 510, among other examples. In such examples, the UE 115-b may transmit one or more repetitions of the third message of 515 (e.g., Msg3 of the RACH) according to the one or more parameters (e.g., whether to transmit the Msg3 PUSCH repetitions via SBFD symbols, non-SBFD symbols, or both). The UE 115-b may additionally apply the one or more parameters associated with Msg3 PUSCH repetition for PUCCH repetition (e.g., PUCCH repetition of Msg4 HARQ-ACK feedback).

In some implementations, for PUCCH repetition across SBFD symbols when configuration 1 is indicated or for PUCCH repetition across SBFD and non-SBFD symbols when configuration 2 is indicated, the UE 115-b may transmit the PUCCH repetitions according to an RSRP threshold. For example, the network entity 105-b may output, via the control signaling, or the like, an indication of an RSRP threshold associated one or more PUCCH repetition transmissions communicated via non-SBFD symbols (e.g., TDD symbols). In such examples, the UE 115-b may utilize (e.g., reuse) the RSRP threshold (e.g., the same RSRP threshold configured for non-SBFD symbols) for one or more PUCCH repetition transmission communicated via SBFD symbols (e.g., in accordance with Configuration 1, Configuration 2, or both). Additionally, or alternatively, the network entity 105-b may output (e.g., via the control signaling) an indication of an additional RSRP threshold associated with the PUCCH repetition transmissions communicated via SBFD symbols. That is, the network entity 105-b may output a first RSRP threshold for PUCCH repetitions via non-SBFD symbols and a second RSRP threshold for PUCCH repetition via SBFD symbols. The UE 115-b may output a set of PUCCH repetitions via non-SBFD symbols according to a respective first RSRP threshold, or may output a set of PUCCH repetitions via SBFD symbols according to a respective second RSRP threshold.

In some implementations, the network entity 105-b may output an indication of one or more repetition factors (e.g., via the control signaling), and the UE 115-b may apply the one or more repetition factors to the PUCCH repetitions. That is, the UE 115-b may transmit a quantity of PUCCH transmissions according to an indicated repetition factor. In some examples, the network entity 105-b may explicitly indicate a repetition factor. In some other examples, the network entity 105-b may indicate a set of repetition factors (e.g., candidate repetition factors) and may indicate (e.g., dynamically indicate) one or more repetition factors of the set of repetition factors for the UE 115-b to apply via control signaling, among other examples. For example, the network entity 105-b may output, via the control signaling, or the like, an indication of repetition factor associated one or more PUCCH repetition transmissions communicated via non-SBFD symbols (e.g., TDD symbols). In such examples, the UE 115-b may utilize (e.g., reuse) the repetition factor (e.g., the same repetition factor configured for non-SBFD symbols) for one or more PUCCH repetition transmission communicated via SBFD symbols (e.g., in accordance with Configuration 1, Configuration 2, or both). Additionally, or alternatively, the network entity 105-b may output (e.g., via the control signaling) an indication of an additional repetition factor associated with the PUCCH repetition transmissions communicated via SBFD symbols. That is, the network entity 105-b may output a first repetition factor for PUCCH repetitions via non-SBFD symbols and a second repetition factor for PUCCH repetition via SBFD symbols.

In some examples, the UE 115-b may utilize (e.g., reuse) the set repetition factors for one or more PUCCH repetitions transmitted via non-SBFD symbols and for one or more PUCCH repetitions transmitted via SBFD symbols (e.g., a same set of repetition factors). Additionally, or alternatively, the network entity 105-b may output (e.g., via the control signaling) an indication of an additional set of repetition factors associated with the PUCCH repetitions communicated via SBFD symbols. That is, the UE 115-b may output a set of PUCCH repetitions via non-SBFD symbols according to a respective first set of repetition factors, and may output a set of PUCCH repetitions via SBFD symbols according to a respective second set of repetition factors (e.g., separate sets of repetition factors). In some examples, the repetition factors for PUCCH repetitions via SBFD symbols may be greater than the repetition factors for PUCCH repetitions via non-SBFD symbols (e.g., to compensate for a lower SINR in SBFD symbols).

In some examples, the respective first set of repetition factors and the respective second set of repetition factors may correspond to a same list size. That is, the network entity 105-b may indicate a same quantity of repetition factors for both PUCCH transmissions via non-SBFD symbols and PUCCH transmissions via SBFD symbols. In such examples, the repetition factor values (e.g., individual repetition factors of the sets of repetition factors) may be different. For an illustrative example, the network entity 105-b may indicate multiple repetition factors from a set of repetition factors including {1, 2, 4, 8}. The network entity 105-b may indicate a first set of repetition factors for PUCCH repetitions via non-SBFD symbols including {1,2} and a second set of repetition factors for PUCCH repetitions via SBFD symbols including {4,8}. In such examples, the list size for both the first set and the second set may be two (e.g., a same list size).

At 525, the network entity 105-b may output, via the control signaling of 520 (e.g., the Msg4) or via additional control signaling (e.g., a DCI message), a first parameter (e.g., a timing indicator). For example, the network entity 105-b may output a DCI message, which may schedule a PDSCH reception, and may include a PDSCH-to-HARQ_feedback timing indicator. The PDSCH-to-HARQ_feedback timing indicator may indicate a threshold time (e.g., an offset time duration) between the PDSCH reception and a first PUCCH repetition (e.g., carrying HARQ-ACK feedback for the PDSCH reception). In some examples, the UE 115-b may determine a symbol type (e.g., SBFD symbols or non-SBFD symbols) for one or more additional PUCCH repetitions based on a symbol type of the first PUCCH repetition, which is further described herein with reference to FIG. 3.

At 530, the network entity 105-b may output, via the control signaling of 520 (e.g., the Msg4) or via additional control signaling, an indication of a frequency offset (e.g., a PRB offset), is further described herein with reference to FIG. 4.

At 535, the UE 115-b may select a set of symbols for the PUCCH repetitions. For example, the UE 115-b may select a set of SBFD symbols, a set of non-SBFD symbols, or a set of both SBFD symbols and non-SBFD symbols in accordance with the control signaling of 520 (e.g., Configuration 1 and Configuration 2, respectively), which is further described herein with reference to FIG. 2. Additionally, or alternatively, the UE 115-b may select a set of frequency resources for the PUCCH repetitions based on the control signaling of 520 (e.g., based on a frequency offset value), among other examples, as further described herein with reference to FIG. 4.

At 540, the UE 115-b may transmit the one or more PUCCH repetitions carrying HARQ-ACK feedback information for the Msg4. The UE 115-b may transmit the PUCCH repetitions according to the selected symbols, the selected frequency resources, or both, which is further described herein with reference to FIG. 2.

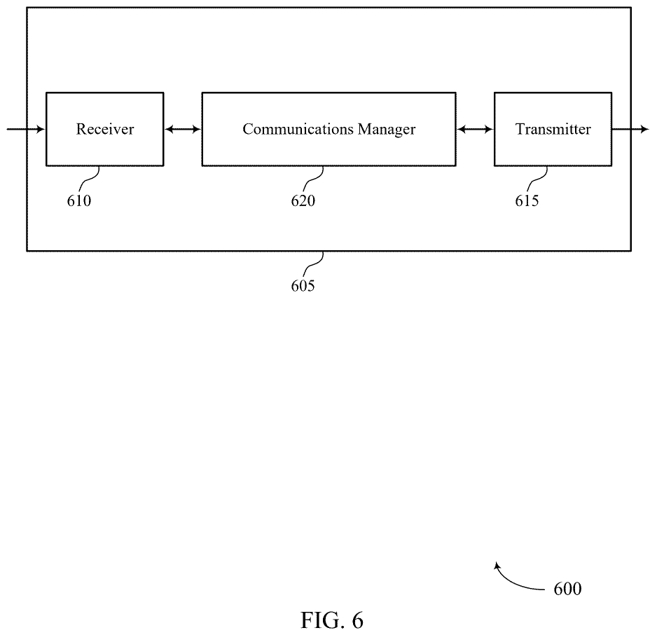

FIG. 6 shows a block diagram 600 of a device 605 that supports uplink control channel repetition without a dedicated resource configuration in SBFD in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor (not shown), which may be coupled with at least one memory (not shown), to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink control channel repetition without a dedicated resource configuration in SBFD). Information may be passed on to other components of the device 605. The receiver 610 may utilize a single antenna or a set of multiple antennas (not shown).

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink control channel repetition without a dedicated resource configuration in SBFD). In some examples, the transmitter 615 may be co-located with a receiver 610 in a transceiver module. The transmitter 615 may utilize a single antenna or a set of multiple antennas (not shown).

The communications manager 620, the receiver 610, the transmitter 615, or various combinations or components thereof may be examples of means for performing various aspects of uplink control channel repetition without a dedicated resource configuration in SBFD as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof (not shown) configured as or otherwise supporting, individually or collectively, a means for performing the functions described in the present disclosure. In some examples, at least one processor (not shown) and at least one memory (not shown) coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (not shown) (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The communications manager 620 is capable of, configured to, or operable to support a means for selecting, for a feedback message corresponding to a random access procedure, at least a subset of the first set of symbols or the second set of symbols in accordance with the first control signaling, and a set of frequency resources in accordance with one or more parameters. The communications manager 620 is capable of, configured to, or operable to support a means for transmitting one or more repetitions of the feedback message via at least the subset of the first set of symbols or the second set of symbols and the set of frequency resources in accordance with the selecting.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and more efficient utilization of communication resources, among other benefits.

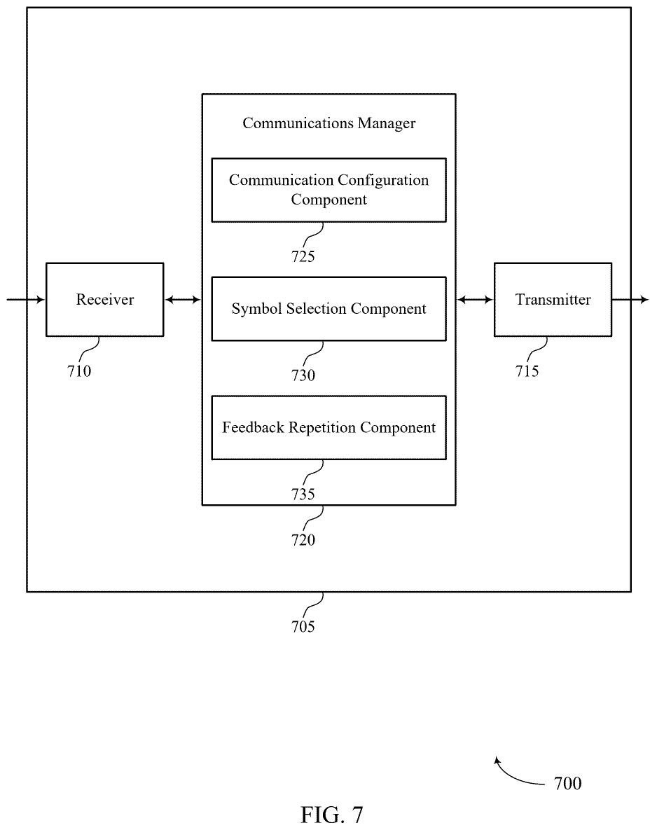

FIG. 7 shows a block diagram 700 of a device 705 that supports uplink control channel repetition without a dedicated resource configuration in SBFD in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor (not shown), which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink control channel repetition without a dedicated resource configuration in SBFD). Information may be passed on to other components of the device 705. The receiver 710 may utilize a single antenna or a set of multiple antennas (not shown).

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink control channel repetition without a dedicated resource configuration in SBFD). In some examples, the transmitter 715 may be co-located with a receiver 710 in a transceiver module. The transmitter 715 may utilize a single antenna or a set of multiple antennas (not shown).

The device 705, or various components thereof, may be an example of means for performing various aspects of uplink control channel repetition without a dedicated resource configuration in SBFD as described herein. For example, the communications manager 720 may include a communication configuration component 725, a symbol selection component 730, a feedback repetition component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The communication configuration component 725 is capable of, configured to, or operable to support a means for receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The symbol selection component 730 is capable of, configured to, or operable to support a means for selecting, for a feedback message corresponding to a random access procedure, at least a subset of the first set of symbols or the second set of symbols in accordance with the first control signaling, and a set of frequency resources in accordance with one or more parameters. The feedback repetition component 735 is capable of, configured to, or operable to support a means for transmitting one or more repetitions of the feedback message via at least the subset of the first set of symbols or the second set of symbols and the set of frequency resources in accordance with the selecting.

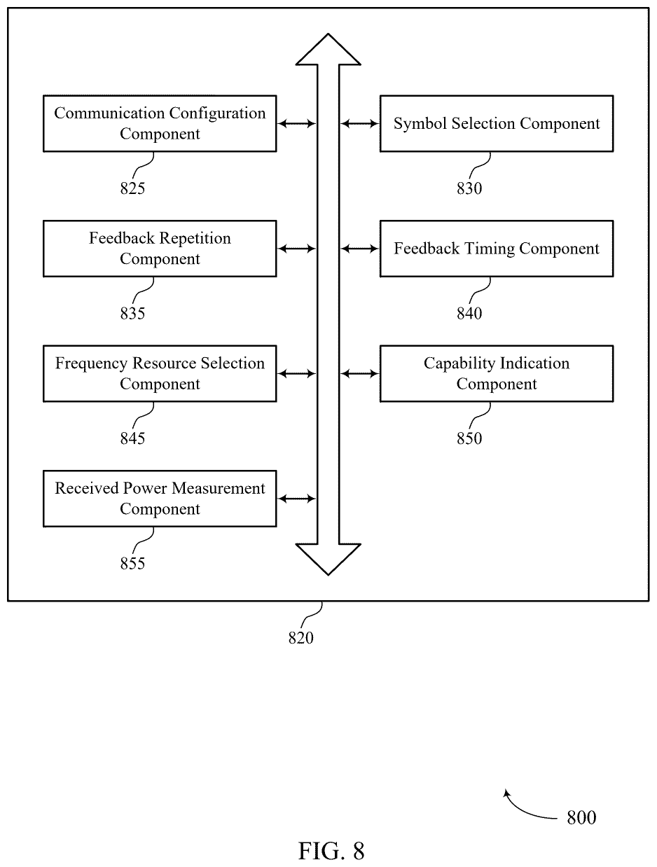

FIG. 8 shows a block diagram 800 of a communications manager 820 that supports uplink control channel repetition without a dedicated resource configuration in SBFD in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink control channel repetition without a dedicated resource configuration in SBFD as described herein. For example, the communications manager 820 may include a communication configuration component 825, a symbol selection component 830, a feedback repetition component 835, a feedback timing component 840, a frequency resource selection component 845, a capability indication component 850, a received power measurement component 855, or any combination thereof. Each of these components, or components or subcomponents thereof (e.g., one or more processors (not shown), one or more memories (not shown)), may communicate, directly or indirectly, with one another (e.g., via one or more buses).

The communications manager 820 may support wireless communications in accordance with examples as disclosed herein. The communication configuration component 825 is capable of, configured to, or operable to support a means for receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The symbol selection component 830 is capable of, configured to, or operable to support a means for selecting, for a feedback message corresponding to a random access procedure, at least a subset of the first set of symbols or the second set of symbols in accordance with the first control signaling, and a set of frequency resources in accordance with one or more parameters. The feedback repetition component 835 is capable of, configured to, or operable to support a means for transmitting one or more repetitions of the feedback message via at least the subset of the first set of symbols or the second set of symbols and the set of frequency resources in accordance with the selecting.

In some examples, the feedback timing component 840 is capable of, configured to, or operable to support a means for receiving second control signaling indicating a first parameter of the one or more parameters, the first parameter indicating a threshold time offset between receiving a downlink message corresponding to the random access procedure and a first repetition of the one or more repetitions of the feedback message. In some examples, the feedback repetition component 835 is capable of, configured to, or operable to support a means for transmitting the first repetition of the feedback message via a next available SBFD symbol of the set of SBFD symbols or a next available non-SBFD symbol of the set of non-SBFD symbols in accordance with the first parameter and the first configuration.

In some examples, the symbol selection component 830 is capable of, configured to, or operable to support a means for determining, in accordance with the first configuration, whether the first repetition was transmitted via an SBFD symbol or a non-SBFD symbol, where selecting at least the subset of the first set of symbols includes selecting the set of SBFD symbols or the set of non-SBFD symbols is based on the determining. In some examples, the feedback repetition component 835 is capable of, configured to, or operable to support a means for transmitting one or more additional repetitions of the one or more repetitions of the feedback message via SBFD symbols or non-SBFD symbols in accordance with the selecting.

In some examples, the frequency resource selection component 845 is capable of, configured to, or operable to support a means for receiving second control signaling indicating a frequency offset, where selecting the set of frequency resources for the feedback message is in accordance with the frequency offset.

In some examples, to support selecting the set of frequency resources, the frequency resource selection component 845 is capable of, configured to, or operable to support a means for selecting, in accordance with the first configuration and the frequency offset, a first subset of frequency resources associated with SBFD symbols, where a second subset of frequency resources is associated with non-SBFD symbols, and where the first subset of frequency resources is offset from the second subset of frequency resources by the frequency offset.

In some examples, to support selecting the set of frequency resources, the frequency resource selection component 845 is capable of, configured to, or operable to support a means for selecting, in accordance with the second configuration and the frequency offset, the set of frequency resources associated with the second set of symbols including both SBFD symbols and non-SBFD symbols, where the set of frequency resources are offset from an indicated frequency resource associated with the non-SBFD symbols by the frequency offset.

In some examples, the capability indication component 850 is capable of, configured to, or operable to support a means for transmitting an indication of whether the UE supports physical uplink control channel repetitions via the first set of symbols in accordance with the first configuration or via the second set of symbols in accordance with the second configuration.

In some examples, the capability indication component 850 is capable of, configured to, or operable to support a means for transmitting the indication via a third message of the random access procedure.

In some examples, the indication includes a logical channel identifier message.

In some examples, the received power measurement component 855 is capable of, configured to, or operable to support a means for receiving second control signaling indicating one or more reference signal received power thresholds. In some examples, the received power measurement component 855 is capable of, configured to, or operable to support a means for applying a reference signal received power threshold to one or more measurements, where transmitting the one or more repetitions of the feedback message is based on the applying.

In some examples, the feedback repetition component 835 is capable of, configured to, or operable to support a means for receiving second control signaling indicating one or more repetition quantities, where transmitting the one or more repetitions of the feedback message is based on the one or more repetition quantities.

In some examples, the first control signaling includes a system information block, a random access response message, downlink control information, or any combination thereof.

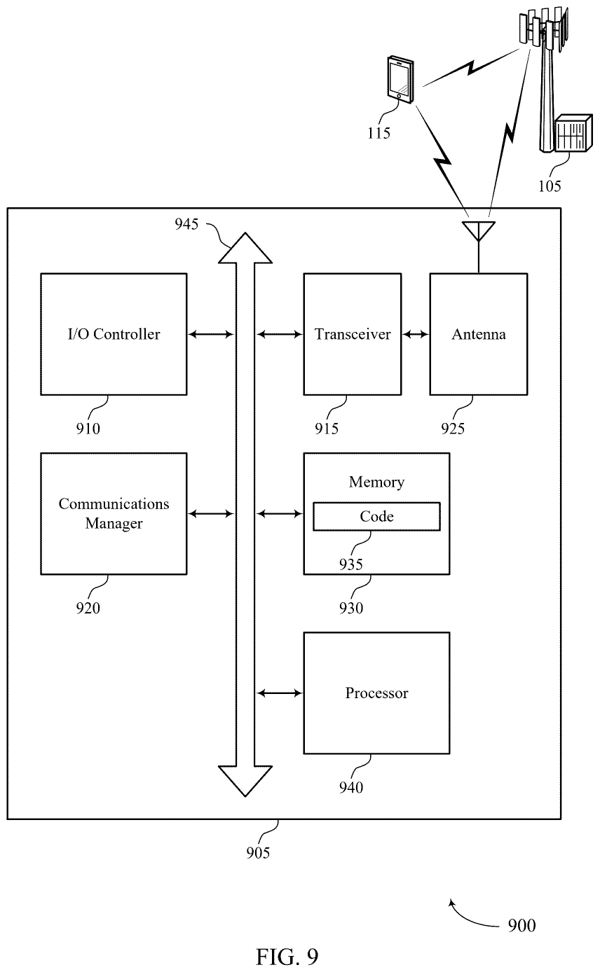

FIG. 9 shows a diagram of a system 900 including a device 905 that supports uplink control channel repetition without a dedicated resource configuration in SBFD in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna (such as the one or more antennas 925). However, in some other cases, the device 905 may have more than one antenna (such as the one or more antennas 925), which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver (not shown). The transceiver 915 may also include a modem (not shown) to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory (such as the at least one memory 930). In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices (not shown).

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array (such as the at least one memory 930) using a memory controller (not shown). In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting uplink control channel repetition without a dedicated resource configuration in SBFD). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The communications manager 920 is capable of, configured to, or operable to support a means for selecting, for a feedback message corresponding to a random access procedure, at least a subset of the first set of symbols or the second set of symbols in accordance with the first control signaling, and a set of frequency resources in accordance with one or more parameters. The communications manager 920 is capable of, configured to, or operable to support a means for transmitting one or more repetitions of the feedback message via at least the subset of the first set of symbols or the second set of symbols and the set of frequency resources in accordance with the selecting.

By including or configuring the communications manager 920 in accordance with examples as described herein, the device 905 may support techniques for reduced latency, improved user experience related to reduced processing more efficient utilization of communication resources, improved coordination between devices and improved utilization of processing capability, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of uplink control channel repetition without a dedicated resource configuration in SBFD as described herein, or the at least one processor 940 and the at least one memory 930 may be otherwise configured to, individually or collectively, perform or support such operations.

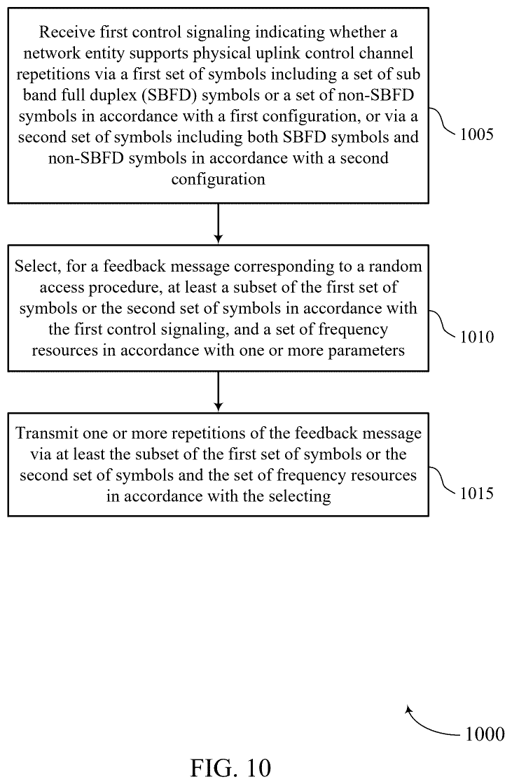

FIG. 10 shows a flowchart illustrating a method 1000 that supports uplink control channel repetition without a dedicated resource configuration in SBFD in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The operations of 1005 may be performed in accordance with examples as disclosed herein. In some examples, aspects of the operations of 1005 may be performed by a communication configuration component 825 as described with reference to FIG. 8.

At 1010, the method may include selecting, for a feedback message corresponding to a random access procedure, at least a subset of the first set of symbols or the second set of symbols in accordance with the first control signaling, and a set of frequency resources in accordance with one or more parameters. The operations of 1010 may be performed in accordance with examples as disclosed herein. In some examples, aspects of the operations of 1010 may be performed by a symbol selection component 830 as described with reference to FIG. 8.

At 1015, the method may include transmitting one or more repetitions of the feedback message via at least the subset of the first set of symbols or the second set of symbols and the set of frequency resources in accordance with the selecting. The operations of 1015 may be performed in accordance with examples as disclosed herein. In some examples, aspects of the operations of 1015 may be performed by a feedback repetition component 835 as described with reference to FIG. 8.

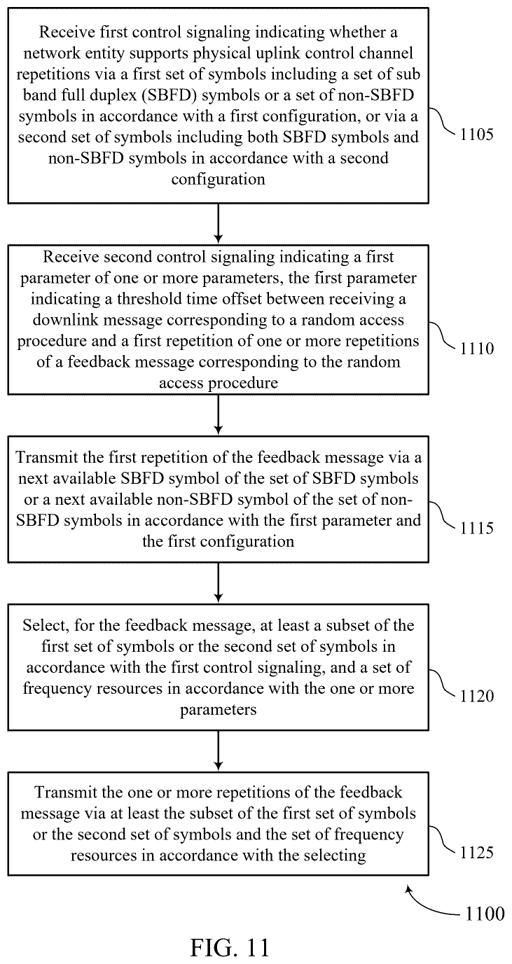

FIG. 11 shows a flowchart illustrating a method 1100 that supports uplink control channel repetition without a dedicated resource configuration in SBFD in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The operations of 1105 may be performed in accordance with examples as disclosed herein. In some examples, aspects of the operations of 1105 may be performed by a communication configuration component 825 as described with reference to FIG. 8.

At 1110, the method may include receiving second control signaling indicating a first parameter of one or more parameters, the first parameter indicating a threshold time offset between receiving a downlink message corresponding to a random access procedure and a first repetition of one or more repetitions of a feedback message corresponding to the random access procedure. The operations of 1110 may be performed in accordance with examples as disclosed herein. In some examples, aspects of the operations of 1110 may be performed by a feedback timing component 840 as described with reference to FIG. 8.

At 1115, the method may include transmitting the first repetition of the feedback message via a next available SBFD symbol of the set of SBFD symbols or a next available non-SBFD symbol of the set of non-SBFD symbols in accordance with the first parameter and the first configuration. The operations of 1115 may be performed in accordance with examples as disclosed herein. In some examples, aspects of the operations of 1115 may be performed by a feedback repetition component 835 as described with reference to FIG. 8.

At 1120, the method may include selecting, for the feedback message, at least a subset of the first set of symbols or the second set of symbols in accordance with the first control signaling, and a set of frequency resources in accordance with the one or more parameters. The operations of 1120 may be performed in accordance with examples as disclosed herein. In some examples, aspects of the operations of 1120 may be performed by a symbol selection component 830 as described with reference to FIG. 8.

At 1125, the method may include transmitting the one or more repetitions of the feedback message via at least the subset of the first set of symbols or the second set of symbols and the set of frequency resources in accordance with the selecting. The operations of 1125 may be performed in accordance with examples as disclosed herein. In some examples, aspects of the operations of 1125 may be performed by a feedback repetition component 835 as described with reference to FIG. 8.

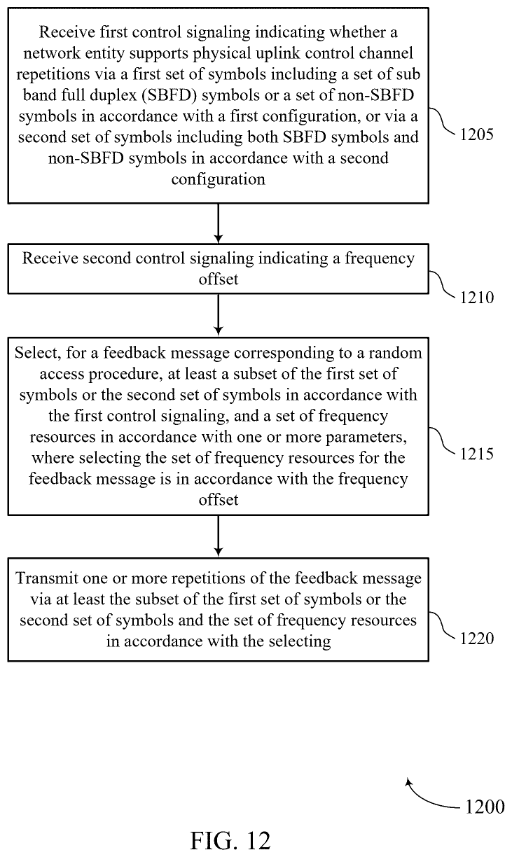

FIG. 12 shows a flowchart illustrating a method 1200 that supports uplink control channel repetition without a dedicated resource configuration in SBFD in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving first control signaling indicating whether a network entity supports physical uplink control channel repetitions via a first set of symbols including a set of SBFD symbols or a set of non-SBFD symbols in accordance with a first configuration, or via a second set of symbols including both SBFD symbols and non-SBFD symbols in accordance with a second configuration. The operations of 1205 may be performed in accordance with examples as disclosed herein. In some examples, aspects of the operations of 1205 may be performed by a communication configuration component 825 as described with reference to FIG. 8.

At 1210, the method may include receiving second control signaling indicating a frequency offset. The operations of 1210 may be performed in accordance with examples as disclosed herein. In some examples, aspects of the operations of 1210 may be performed by a frequency resource selection component 845 as described with reference to FIG. 8.

At 1215, the method may include selecting, for a feedback message corresponding to a random access procedure, at least a subset of the first set of symbols or the second set of symbols in accordance with the first control signaling, and a set of frequency resources in accordance with one or more parameters, where selecting the set of frequency resources for the feedback message is in accordance with the frequency offset. The operations of 1215 may be performed in accordance with examples as disclosed herein. In some examples, aspects of the operations of 1215 may be performed by a symbol selection component 830 as described with reference to FIG. 8.

At 1220, the method may include transmitting one or more repetitions of the feedback message via at least the subset of the first set of symbols or the second set of symbols and the set of frequency resources in accordance with the selecting. The operations of 1220 may be performed in accordance with examples as disclosed herein. In some examples, aspects of the operations of 1220 may be performed by a feedback repetition component 835 as described with reference to FIG. 8.

The following provides an overview of aspects of the present disclosure:

Aspect 1: A method for wireless communications at a UE, comprising: receiving first control signaling indicating whether a network entity supports PUCCH repetitions via a first set of symbols comprising a set of SBFD symbols or a set of non-SBFD symbols in accordance with a first configuration, or via a second set of symbols comprising both SBFD symbols and non-SBFD symbols in accordance with a second configuration; selecting, for a feedback message corresponding to a RACH procedure, at least a subset of the first set of symbols or the second set of symbols in accordance with the first control signaling, and a set of frequency resources in accordance with one or more parameters; and transmitting one or more repetitions of the feedback message via at least the subset of the first set of symbols or the second set of symbols and the set of frequency resources in accordance with the selecting.

Aspect 2: The method of aspect 1, further comprising: receiving second control signaling indicating a first parameter of the one or more parameters, the first parameter indicating a threshold time offset between receiving a downlink message corresponding to the RACH procedure and a first repetition of the one or more repetitions of the feedback message; and transmitting the first repetition of the feedback message via a next available SBFD symbol of the set of SBFD symbols or a next available non-SBFD symbol of the set of non-SBFD symbols in accordance with the first parameter and the first configuration.

Aspect 3: The method of aspect 2, further comprising: determining, in accordance with the first configuration, whether the first repetition was transmitted via an SBFD symbol or a non-SBFD symbol, wherein selecting at least the subset of the first set of symbols comprises selecting the set of SBFD symbols or the set of non-SBFD symbols is based at least in part on the determining; and transmitting one or more additional repetitions of the one or more repetitions of the feedback message via SBFD symbols or non-SBFD symbols in accordance with the selecting.

Aspect 4: The method of any of aspects 1 through 3, further comprising: receiving second control signaling indicating a frequency offset, wherein selecting the set of frequency resources for the feedback message is in accordance with the frequency offset.

Aspect 5: The method of aspect 4, wherein selecting the set of frequency resources further comprises: selecting, in accordance with the first configuration and the frequency offset, a first subset of frequency resources associated with SBFD symbols, wherein a second subset of frequency resources is associated with non-SBFD symbols, and wherein the first subset of frequency resources is offset from the second subset of frequency resources by the frequency offset.

Aspect 6: The method of aspect 4, wherein selecting the set of frequency resources further comprises: selecting, in accordance with the second configuration and the frequency offset, the set of frequency resources associated with the second set of symbols comprising both SBFD symbols and non-SBFD symbols, wherein the set of frequency resources are offset from an indicated frequency resource associated with the non-SBFD symbols by the frequency offset.

Aspect 7: The method of any of aspects 1 through 6, further comprising: transmitting an indication of whether the UE supports PUCCH repetitions via the first set of symbols in accordance with the first configuration or via the second set of symbols in accordance with the second configuration.

Aspect 8: The method of aspect 7, further comprising: transmitting the indication via a third message of the RACH procedure.

Aspect 9: The method of any of aspects 7 through 8, wherein the indication comprises a LCID message.

Aspect 10: The method of any of aspects 1 through 9, further comprising: receiving second control signaling indicating one or more RSRP thresholds; and applying a RSRP threshold to one or more measurements, wherein transmitting the one or more repetitions of the feedback message is based at least in part on the applying.

Aspect 11: The method of any of aspects 1 through 10, further comprising: receiving second control signaling indicating one or more repetition quantities, wherein transmitting the one or more repetitions of the feedback message is based at least in part on the one or more repetition quantities.

Aspect 12: The method of any of aspects 1 through 11, wherein the first control signaling comprises a SIB, a RAR message, DCI, or any combination thereof.

Aspect 13: A UE for wireless communications, comprising at least one processor, and at least one memory coupled with the at least one processor, with instructions stored in the at least one memory, the instructions being executable by the at least one processor, individually or in any combination, to cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
receive first control signaling indicating whether a network entity supports physical uplink control channel repetitions via a first set of symbols comprising a set of sub-band full duplex (SBFD) symbols or a set of non-SBFD symbols in accordance with a first configuration, or via a second set of symbols comprising both SBFD symbols and non-SBFD symbols in accordance with a second configuration;
select, for a feedback message corresponding to a random access procedure, at least a subset of the first set of symbols or the second set of symbols in accordance with the first control signaling, and a set of frequency resources in accordance with one or more parameters; and
transmit one or more repetitions of the feedback message via at least the subset of the first set of symbols or the second set of symbols and the set of frequency resources in accordance with the selecting.

2. The UE of claim 1, wherein the at least one processor is further operable to execute the instructions to cause the UE to:
receive second control signaling indicating a first parameter of the one or more parameters, the first parameter indicating a threshold time offset between receiving a downlink message corresponding to the random access procedure and a first repetition of the one or more repetitions of the feedback message; and
transmit the first repetition of the feedback message via a next available SBFD symbol of the set of SBFD symbols or a next available non-SBFD symbol of the set of non-SBFD symbols in accordance with the first parameter and the first configuration.

3. The UE of claim 2, wherein the at least one processor is further operable to execute the instructions to cause the UE to:
determine, in accordance with the first configuration, whether the first repetition was transmitted via an SBFD symbol or a non-SBFD symbol, wherein selecting at least the subset of the first set of symbols comprises selecting the set of SBFD symbols or the set of non-SBFD symbols is based at least in part on the determining; and
transmit one or more additional repetitions of the one or more repetitions of the feedback message via SBFD symbols or non-SBFD symbols in accordance with the selecting.

4. The UE of claim 1, wherein the at least one processor is further operable to execute the instructions to cause the UE to:
receive second control signaling indicating a frequency offset, wherein selecting the set of frequency resources for the feedback message is in accordance with the frequency offset.

5. The UE of claim 4, wherein, to select the set of frequency resources, the at least one processor is further operable to execute the instructions to cause the UE to:
select, in accordance with the first configuration and the frequency offset, a first subset of frequency resources associated with SBFD symbols, wherein a second subset of frequency resources is associated with non-SBFD symbols, and wherein the first subset of frequency resources is offset from the second subset of frequency resources by the frequency offset.

6. The UE of claim 4, wherein, to select the set of frequency resources, the at least one processor is further operable to execute the instructions to cause the UE to:
select, in accordance with the second configuration and the frequency offset, the set of frequency resources associated with the second set of symbols comprising both SBFD symbols and non-SBFD symbols, wherein the set of frequency resources are offset from an indicated frequency resource associated with the non-SBFD symbols by the frequency offset.

7. The UE of claim 1, wherein the at least one processor is further operable to execute the instructions to cause the UE to:
transmit an indication of whether the UE supports physical uplink control channel repetitions via the first set of symbols in accordance with the first configuration or via the second set of symbols in accordance with the second configuration.

8. The UE of claim 7, wherein the at least one processor is further operable to execute the instructions to cause the UE to:
transmit the indication via a third message of the random access procedure.

9. The UE of claim 7, wherein the indication comprises a logical channel identifier message.

10. The UE of claim 1, wherein the at least one processor is further operable to execute the instructions to cause the UE to:
receive second control signaling indicating one or more reference signal received power thresholds; and
apply a reference signal received power threshold to one or more measurements, wherein transmitting the one or more repetitions of the feedback message is based at least in part on the applying.

11. The UE of claim 1, wherein the at least one processor is further operable to execute the instructions to cause the UE to:
receive second control signaling indicating one or more repetition quantities, wherein transmitting the one or more repetitions of the feedback message is based at least in part on the one or more repetition quantities.

12. The UE of claim 1, wherein the first control signaling comprises a system information block, a random access response message, downlink control information, or any combination thereof.

13. A method for wireless communications at a user equipment (UE), comprising:
receiving first control signaling indicating whether a network entity supports physical uplink control channel repetitions via a first set of symbols comprising a set of sub-band full duplex (SBFD) symbols or a set of non-SBFD symbols in accordance with a first configuration, or via a second set of symbols comprising both SBFD symbols and non-SBFD symbols in accordance with a second configuration;
selecting, for a feedback message corresponding to a random access procedure, at least a subset of the first set of symbols or the second set of symbols in accordance with the first control signaling, and a set of frequency resources in accordance with one or more parameters; and
transmitting one or more repetitions of the feedback message via at least the subset of the first set of symbols or the second set of symbols and the set of frequency resources in accordance with the selecting.

14. The method of claim 13, further comprising:
receiving second control signaling indicating a first parameter of the one or more parameters, the first parameter indicating a threshold time offset between receiving a downlink message corresponding to the random access procedure and a first repetition of the one or more repetitions of the feedback message; and
transmitting the first repetition of the feedback message via a next available SBFD symbol of the set of SBFD symbols or a next available non-SBFD symbol of the set of non-SBFD symbols in accordance with the first parameter and the first configuration.

15. The method of claim 14, further comprising:
determining, in accordance with the first configuration, whether the first repetition was transmitted via an SBFD symbol or a non-SBFD symbol, wherein selecting at least the subset of the first set of symbols comprises selecting the set of SBFD symbols or the set of non-SBFD symbols is based at least in part on the determining; and
transmitting one or more additional repetitions of the one or more repetitions of the feedback message via SBFD symbols or non-SBFD symbols in accordance with the selecting.

16. The method of claim 13, further comprising:
receiving second control signaling indicating a frequency offset, wherein selecting the set of frequency resources for the feedback message is in accordance with the frequency offset.

17. The method of claim 16, wherein selecting the set of frequency resources further comprises:
selecting, in accordance with the first configuration and the frequency offset, a first subset of frequency resources associated with SBFD symbols, wherein a second subset of frequency resources is associated with non-SBFD symbols, and wherein the first subset of frequency resources is offset from the second subset of frequency resources by the frequency offset.

18. The method of claim 16, wherein selecting the set of frequency resources further comprises:
selecting, in accordance with the second configuration and the frequency offset, the set of frequency resources associated with the second set of symbols comprising both SBFD symbols and non-SBFD symbols, wherein the set of frequency resources are offset from an indicated frequency resource associated with the non-SBFD symbols by the frequency offset.

19. The method of claim 13, further comprising:
transmitting an indication of whether the UE supports physical uplink control channel repetitions via the first set of symbols in accordance with the first configuration or via the second set of symbols in accordance with the second configuration.

20. A non-transitory computer-readable medium storing code for wireless communications, the code comprising instructions executable by one or more processors to:
receive first control signaling indicating whether a network entity supports physical uplink control channel repetitions via a first set of symbols comprising a set of sub-band full duplex (SBFD) symbols or a set of non-SBFD symbols in accordance with a first configuration, or via a second set of symbols comprising both SBFD symbols and non-SBFD symbols in accordance with a second configuration;
select, for a feedback message corresponding to a random access procedure, at least a subset of the first set of symbols or the second set of symbols in accordance with the first control signaling, and a set of frequency resources in accordance with one or more parameters; and
transmit one or more repetitions of the feedback message via at least the subset of the first set of symbols or the second set of symbols and the set of frequency resources in accordance with the selecting.
